(19) United States
(12) Patent Application Publication
(10) Pub. No.: US 2017/0359259 A1
(43) Pub. Date: Dec. 14, 2017

(54) PACKET FIELD MATCHING IN OPENFLOW

(71) Applicant: HEWLETT PACKARD ENTERPRISE DEVELOPMENT LP, Houston, TX (US)

(72) Inventor: Abhay Bhaskar, Bangalore (IN)

(21) Appl. No.: 15/494,706

(22) Filed: Apr. 24, 2017

(30) Foreign Application Priority Data
Jun. 9, 2016 (IN) 201641019842

(51) Int. Cl. H04L 12/741; H04L 12/721

(52) U.S. Cl. CPC H04L 45/745; H04L 45/38

(57) ABSTRACT

Examples disclosed herein relate to matching a packet field in OpenFlow. In an example, an SDN controller may define a custom match field in a flow table entry of an OpenFlow table in a network switch. The network switch may use the custom match field to match against a packet field in a received packet.

### BACKGROUND

A software defined network (SDN) is based on a network architecture that decouples the control plane from the data plane. The control plane is implemented in an SDN controller and the data plane is implemented in the networking infrastructure (e.g., switches and routers). In software defined networking, data forwarding on a network device is controlled through flow table entries populated by the SDN controller that manages the control plane for that network. OpenFlow is a leading protocol for implementing software defined networking.

### BRIEF DESCRIPTION OF THE DRAWINGS

For a better understanding of the solution, examples will now be described, purely by way of example, with reference to the accompanying drawings, in which:

FIG. 1 is a block diagram of an example network system for matching a packet field in OpenFlow;

FIG. 2 illustrates a block diagram of an example custom match field;

FIG. 3 illustrate a block diagram of an example custom match field for a TCP sequence number;

FIG. 4 illustrates a block diagram of an example custom match field in a flow;

FIG. 5 illustrate a block diagram of an example custom match field in a flow for a TCP sequence number;

FIG. 6 is a bock diagram of an example network device for matching a packet field in OpenFlow;

FIG. 7 is a flow chart of an example method of matching a packet field in OpenFlow; and

FIG. 8 is a block diagram of an example system for matching a packet field in OpenFlow.

### DETAILED DESCRIPTION

Software defined networking (SDN) is an approach to networking in which control is decoupled from networking equipment and given to a device called a controller (or SDN controller). The controller is aware of all the devices and their points of interconnection in a SDN network and may perform various functions such as routing, policy implementation, receiving unknown flow packets, path resolution, flow programming, etc. Each new or missed flow through the network is routed via the controller that decides the network path for a flow and adds an entry for that flow in a flow table, in each of the network devices along the path. A SDN enabled device consults a flow table(s) for forwarding packets in the data plane. Each forwarding rule (flow entry) includes an action that dictates how traffic that matches the rule is to be handled.

OpenFlow is a leading protocol for implementing SDN architecture. An OpenFlow enabled network device (for example, a network switch) may include a flow table(s), which may perform packet lookups and forwarding. The switch may be managed by an external controller via the OpenFlow protocol. Using the OpenFlow protocol, the controller may add, update, and delete flow entries in flow tables. Each flow table in the switch may contain a set of flow entries. Each flow entry consists of match fields, counters, and a set of instructions to apply to matching packets. The match fields may be used for matching packets. Match fields may be used to match against various header fields of a packet. In an example, the packet header of a packet is parsed to extract its header fields which may be matched against corresponding match fields. A packet matches a flow table entry if the values in the packet match fields used for the lookup match those defined in the flow table entry.

The OpenFlow protocol defines a default set of match fields that may be used by an SDN controller to identify which fields in the packet it wants to match and modify in any given flow on a flow table. By using these fixed set of match fields, an SDN controller may match and manipulate different types of network packets. However, there are other packet fields or network protocols (for example, Generic Routing Encapsulation (GRE) protocol) that are not supported by the OpenFlow protocol. The present OpenFlow protocol is not flexible to match on arbitrary packet fields. Needless to say, this is not a desirable situation.

To address this issue, the present disclosure describes various examples of matching a packet field in OpenFlow. In an example, an SDN controller may define a custom match field in a flow table entry of an OpenFlow table in a network switch. The network switch may then use the custom match field in the flow table entry to match against a packet field in a received packet. The proposed solution provides packet matching independently of any network protocol implementation.

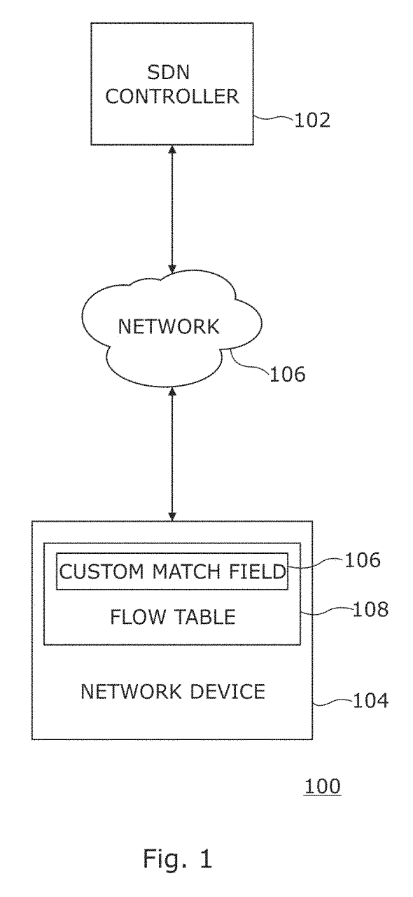

FIG. 1 is a block diagram of an example network system 100 for matching a packet field in Open Flow.

Network system 100 may include a Software Defined Network (SDN) controller 102 and a network device 104. Although one SDN controller 102 and one network device are shown in FIG. 1, other examples of this disclosure may include more than one SDN controller and more than one network device. In an example, network system 100 may include one or more computer systems or an end user device(s) (not shown) that may be the source or destination of packet flows into network system 100. In an example, network system 100 may be based on software-defined networking (SDN) architecture.

SDN controller 102 may be any server, computing device, or the like. In an example, SDN controller 102 may be a computer application (machine-executable instructions). SDN controller 102 may define the data flow that occurs in network system 100. In other words, SDN controller 102 may determine how packets should flow through the network devices 104 of network system 100. SDN controller 102 may communicate with network device 104 via a standardized protocol (example, OpenFlow) or a suitable API.

SDN controller 102 may maintain all network rules and provide appropriate instructions (such as forwarding instructions) to network device 104. SDN controller 102 may centralize the network intelligence, while network maintains a distributed forwarding plane through network device 104. In other words, SDN controller 102 may become aware of the network topology prior to computing forwarding paths in network system 100. SDN controller 102 then programs rules on each network device (for example, 104) which may be used by network device to forward packets to another device in the network 100. In an example, aforesaid programming rules may take the form of a flow entry in one or more flow tables in network device (for example, 104). Each flow entry may be associated with an action (example, forward, redirect, drop, etc.) that describes what process may be followed with respect to a flow that corresponds to a flow entry. SDN controller 102 thus controls the way data packets are forwarded in network 100.

SDN controller 102 may communicate with network device 104 over a computer network 106. The computer network 106 may be a wireless or wired network. The computer network 106 may include, for example, a Local Area Network (LAN), a Wireless Local Area Network (WAN), a Metropolitan Area Network (MAN), a Storage Area Network (SAN), a Campus Area Network (CAN), or the like. Further, the computer network 106 may be a public network (for example, the Internet) or a private network (for example, an intranet).

Network device 104 may include, by way of non-limiting examples, a network switch, a network router, a virtual switch, and a virtual router. In an example, network device 104 may be an SDN enabled device or an OpenFlow enabled device.

Network device 104 may include one or more flow tables. Each flow table in network device 104 may contain a flow entry (or flow entries). SDN controller 102 may add, update, and delete flow entries 106 in flow tables both reactively (in response to packets) and proactively. Network device 104 may communicate with SDN controller 102 and the controller 102 may manage the device via a standardized protocol such as OpenFlow. For instance, network device 104 may forward the first packet of a flow to SDN controller 102, enabling the controller 102 to decide whether the flow should be added to a flow table in the network device 104. Network device 104 thus may accept directions from an SDN controller 102 to change values in a flow table.

A flow table matches an incoming packet to a particular flow and specifies the function that may be performed on the packet. If a flow entry matching with a flow is found in a flow table, instructions associated with the specific flow entry may be executed. A packet matches a flow table entry if the values in the packet match fields used for the lookup match those defined in the flow table entry.

SDN controller 102 may define a custom match field(s) 106 in a flow table entry of an OpenFlow table 108 on a network device (for example, a network switch). OpenFlow protocol defines a default set of match fields with oxm_class=OFPXMC_OPENFLOW_BASIC. For example, OpenFlow specification version 1.5 defines 44 default match fields. These match fields may be used to match against various packet match fields of a packet. Some examples of the default match fields may include: switch input port, switch physical input port, VLAN ID, VLAN priority, TCP source port, and IPv4 source address. SDN controller 102 may define a custom match field in a flow table entry of an OpenFlow table on network device 104 that may be matched against any packet match field of a packet. In an example, the packet match field may be presently unsupported by OpenFlow protocol. In another words, a custom match field may be other than an OpenFlow default match field. For example, SDN controller 102 may define a custom match field that may be matched against a packet match field of a network protocol presently unsupported by OpenFlow protocol. Some examples of such network protocol may include Internet Group Management Protocol (IGMP), Generic Routing Encapsulation (GRE) protocol, and Open Shortest Path First (OSPF) protocol.

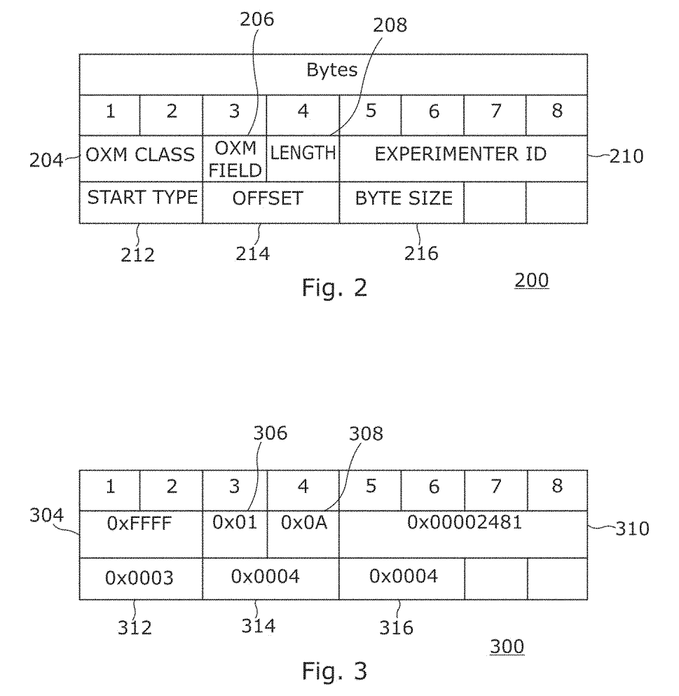

In an example, a custom match field defined by SDN controller 102 may be defined using OpenFlow Extensible Match (OXM) format. The OXM format is a type-length-value (TLV) format. FIG. 2 illustrates a block diagram of an example custom match field 200. Referring to FIG. 2, the example custom match field may be an OXM TLV. The OXM TLV may be 5 to 259 bytes long. The first 4 bytes of the OXM TLV may include its header, followed by the entry's body. The OXM TLV's header fields may include oxm_class 204, oxm_field 206, and oxm_length 208. oxm_class 204 may be an OXM match class that contains related match types. oxm_field 206 may be a class-specific value that may identify one of the match types within the match class. oxm_length 208 may be a positive integer that may describe the length of the OXM TLV payload in bytes. The length of the OXM TLV, including the header, may be 4+oxm_length bytes.

In an example, a custom match field may be defined using OFPXMC_EXPERIMENTER class. In such case, the oxm_class field in the OXM header may be set to OFPXMC_EXPERIMENTER. The oxm_field field in the OXM header may be the experimenter type. The oxm_field may be a unique value that may be used to distinguish a custom match field from other custom match fields. The value of the oxm_field may be pre-agreed between SDN controller 102 and network device 104.

The experimenter identifier and the experimenter type may together identify the experimenter match field. The experimenter field may be encoded in the first four bytes of the OXM TLV's body. It may contain the experimenter identifier. OFPXMC_EXPERIMENTER class may include an experimenter header between the OXM TLV header and the value in the payload.

The EXPERIMENTER ID field 210 may be a 32-bit value that uniquely identifies the experimenter i.e. the entity (or vendor) that may define the experimenter extension. For example, the EXPERIMENTER ID may include the experimenter's IEEE OUI. In another example, the EXPERIMENTER ID may include a unique experimenter ID.

The START TYPE field 212 may define the location of data in a packet that may be used for matching with a custom match field. For example, if a layer 2 data is to be matched in a packet received on network device 104 against a custom match field defined by SDN controller 102, START TYPE field may be defined as L2_START=1/* Look from L2 header */. Likewise, for a layer 3 data, START TYPE field may be defined as L3_START=2/* Look from L3 header */. In another example, for a layer 4 data, START TYPE field may be defined as L4_START=3/* Look from L4 header */.

The OFFSET field 214 may define the byte offset from the ‘START TYPE’ where the match field may begin. The BYTE SIZE field 216 may define the number of bytes to match from the ‘OFFSET’. The BYTE SIZE may reflect the number of bytes of data that may be matched between the custom match field and the packet field in a packet.

FIG. 3 illustrate a block diagram of an example custom match field 300 for a TCP sequence number. Referring to FIG. 3, the custom match field 300 may a 4 byte field that may begin at an offset of 4 bytes from the start of an L4 header. The oxm_class 304 may be 0xFFFF, oxm_field 306 may be 0x01, oxm_length 308 may be 0x0A, EXPERIMENTER ID 310 may be 0x00002481, START TYPE 312 may be 0x0003, OFFSET 314 may be 0x0004, and BYTE SIZE 316 may be 0x0004.

In an example, using a custom match field to match against a packet field in a received packet may be pre-agreed between SDN controller 102 and network device 104. The contents of the custom match field may be pre-agreed between SDN controller 102 and network device 104 as well. SDN controller 102 may use OFPTFPT_MATCH table feature property type of Open Flow protocol to define the custom match field for a flow table.

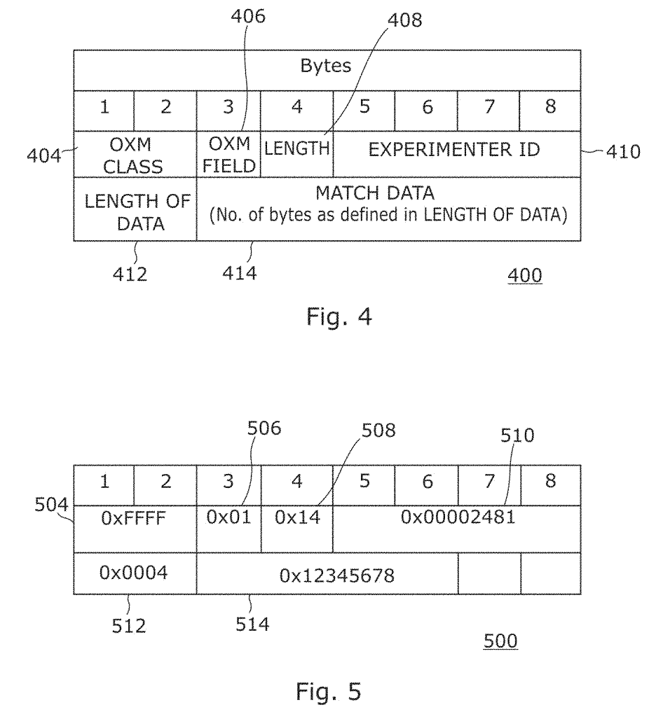

Once a custom match field(s) is created in a flow table on network device 104, SDN controller may program flows to match on the custom match field via the OFPT_FLOW_MOD message. The data for the custom match field may be embedded as an OXM TLV within an OFPT_FLOW_MOD message. FIG. 4 illustrates a block diagram of an example custom match field 400 that may be included within an OFPT_FLOW_MOD message. Referring to FIG. 4, the OXM TLV may include an oxm_class field 404, an oxm_field field 406, an oxm_length field 408, an EXPERIMENTER ID field 410, a LENGTH OF DATA field 412, and a MATCH DATA field 414.

The oxm_class field 404 may include the OFPXMC_EXPERIMENTER class field. The oxm_field 406 may include the same unique value that was used in defining the custom match field. The oxm_length 408 may be a positive integer that may describe the length of the OXM TLV payload in bytes. The length of the OXM TLV, including the header, may be 4+oxm_length bytes. The EXPERIMENTER ID field 410 may be a 32-bit value that uniquely identifies the experimenter i.e. the entity (or vendor) that may define the experimenter extension. For example, the EXPERIMENTER ID may include the experimenter's IEEE OUI. In another example, the EXPERIMENTER ID may include a unique experimenter ID. The EXPERIMNTER ID field may include the same value that was used in defining the custom match field.

The LENGTH OF DATA field 412 may define the number of bytes of data that may be matched between the custom match field and the packet field in a packet. The LENGTH OF DATA value may be equivalent to value defined under the BYTE SIZE field of the custom match field.

The MATCH DATA field 414 may include the data that may be matched between the custom match field and the packet field in a packet. In other words, the MATCH DATA field may include the data that may be compared between a custom match field and a packet field when a packet is received at network device 104.

FIG. 5 illustrate a block diagram of an example custom match field 500 in a flow for a TCP sequence number. Referring to FIG. 5, the oxm_class 504 may be 0xFFFF, oxm_field 506 may be 0x01, oxm_length 508 may be 0x14, EXPERIMENTER ID 510 may be 0x00002481, LENGTH OF DATA 512 may be 0x0004, and MATCH DATA 514 may be 0x12345678.

SDN controller 102 may define a custom match field(s) in more than one OpenFlow table on network device 104. In such case, SDN controller 102 may create an OpenFlow pipeline with such tables using OFPTFPT_MATCH table feature property type of OpenFlow protocol.

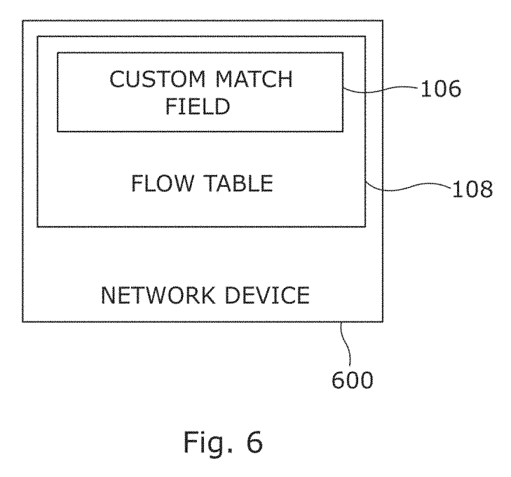

FIG. 6 is a block diagram of an example network device 600 for matching a packet field in OpenFlow. In an example, network device 600 may be analogous to network devices 104 of FIG. 1, in which like reference numerals correspond to the same or similar, though perhaps not identical, components. For the sake of brevity, components or reference numerals of FIG. 6 having a same or similarly described function in FIG. 1 are not being described in connection with FIG. 6. Said components or reference numerals may be considered alike.

Network device 600 may include, for instance, a network switch, a virtual switch, a network router, a virtual router, or any network device capable of performing switching and/or routing-related functions. In an example, network device 600 may be an SDN enabled device or an OpenFlow enabled device.

Network device 600 may include one or more flow tables. Each flow table in network device 600 may contain a flow entry (or flow entries). An SDN controller (for example, 102) may add, update, and delete flow entries in flow tables both reactively (in response to packets) and proactively. Network device 600 may communicate with the SDN controller and the controller may manage the device via a standardized protocol such as OpenFlow. For instance, network device 600 may forward the first packet of a flow to the SDN controller, enabling the controller to decide whether the flow should be added to a flow table in network device 600. Network device 600 thus may accept directions from the SDN controller to change values in a flow table.

A flow table matches an incoming packet to a particular flow and specifies the function that may be performed on the packet. If a flow entry matching with a flow is found in a flow table, instructions associated with the specific flow entry may be executed. A packet matches a flow table entry if the values in the packet match fields used for the lookup match those defined in the flow table entry.

Network device 600 may include a custom match field(s) 106 in a flow table entry (or entries) of an OpenFlow table(s) 108. The custom math field(s) may be defined by an SDN controller (for example, 102). In an example, a custom match field may be matched against any packet match field of a packet received at network device 600. In an example, the packet match field may be presently unsupported by OpenFlow protocol. In another words, a custom match field may be other than an OpenFlow default match field. For example, a custom match field may be matched against a packet match field of a network protocol presently unsupported by OpenFlow protocol. Some examples of such network protocol may include Internet Group Management Protocol (IGMP), Generic Routing Encapsulation (GRE) protocol, and Open Shortest Path First (OSPF) protocol.

In an example, a custom match field on network device 600 may be defined using a type-length-value (TLV) format. For example, a custom match field may be defined using OpenFlow Extensible Match (OXM) format. FIG. 2 illustrates a block diagram of an example custom match field that may be defined on network device. For the sake of brevity, components or reference numerals of FIG. 2 are not being described in connection with FIG. 6. For details related to the components or reference numerals, reference may be made to the earlier description.

In an example, network device 600 may use the custom match field(s) in a flow table to match against a packet received on the network device. In the event of a match, network device 600 may execute the instructions set included in the flow table entry that includes the custom match field.

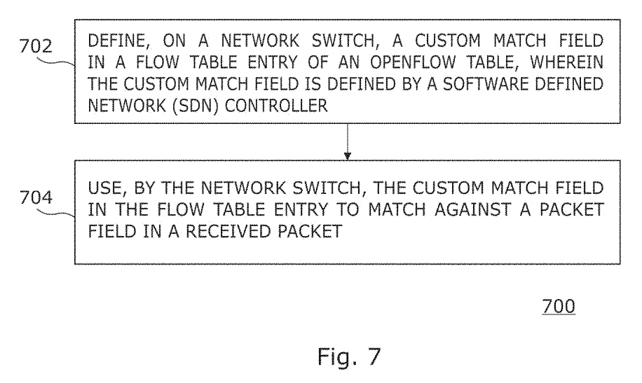

FIG. 7 is a block diagram of an example method 700 for matching a packet field in OpenFlow. The method 700, which is described below, may be partially executed on a computing device such as network device 104 of FIG. 1 or network device 600 of FIG. 6. However, other suitable computing devices may execute method 700 as well. At block 702, a custom match field may be defined in a flow table entry of an OpenFlow table on a network switch, wherein the custom match field may be defined by a Software Defined Network (SDN) controller. At block 704, the network switch may use the custom match field in the flow table entry to match against a packet field in a received packet.

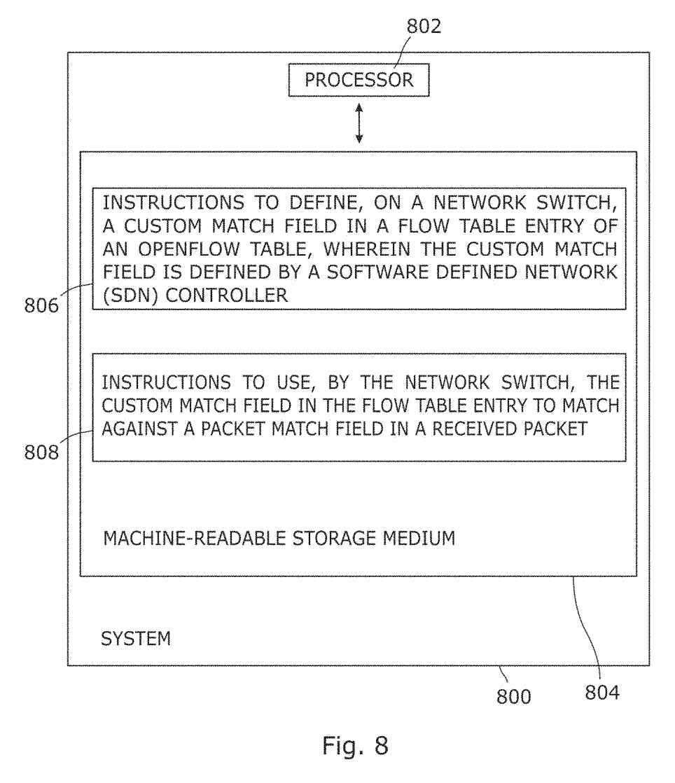

FIG. 8 is a block diagram of an example system 800 for matching a packet field in OpenFlow. System 800 includes a processor 802 and a machine-readable storage medium 804 communicatively coupled through a system bus. In an example, system 800 may be analogous to network device 104 or network device 600 of FIG. 6. Processor 802 may be any type of Central Processing Unit (CPU), microprocessor, or processing logic that interprets and executes machine-readable instructions stored in machine-readable storage medium 804. Machine-readable storage medium 804 may be a random access memory (RAM) or another type of dynamic storage device that may store information and machine-readable instructions that may be executed by processor 802. For example, machine-readable storage medium 804 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 804 may store instructions 806 and 808. In an example, instructions 806 may be executed by processor 802 to define, on a network switch, a custom match field in a flow table entry of an OpenFlow table, wherein the custom match field may be defined by a Software Defined Network (SDN) controller. Instructions 808 may be executed by processor 802 to use, by the network switch, the custom match field in the flow table entry to match against a packet match field in a received packet.

For the purpose of simplicity of explanation, the example method of FIG. 7 is shown as executing serially, however it is to be understood and appreciated that the present and other examples are not limited by the illustrated order. The example systems of FIGS. 1, 6, and 8, and method of FIG. 7 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution. All of the features disclosed in this specification (including any accompanying claims, abstract and drawings), and/or all of the stages of any method or process so disclosed, may be combined in any combination, except combinations where at least some of such features and/or stages are mutually exclusive.

1. A method of matching a packet field in OpenFlow, comprising:
defining, on a network switch, a custom match field in a flow table entry of an OpenFlow table, wherein the custom match field is defined by a Software Defined Network (SDN) controller; and
using, by the network switch, the custom match field in the flow table entry to match against a packet field in a received packet.

2. The method of claim 1, wherein the custom match field is other than a default match field defined by OpenFlow protocol.

3. The method of claim 1, wherein using the custom match field to match against the packet field in the received packet is pre-agreed between the SDN controller and the network switch.

4. The method of claim 1, wherein contents of the custom match field are pre-agreed between the SDN controller and the network switch.

5. The method of claim 1, further comprising defining an OpenFlow pipeline on the network switch to match on the custom match field.

6. A network device for matching a packet field in OpenFlow, comprising:
a custom match field in a flow table entry of an OpenFlow table, wherein the custom match field is defined by an OpenFlow controller, and wherein the custom match field in the flow table entry is used to match against a packet received on the network device.

7. The network device of claim 6, wherein the custom match field includes a unique value that distinguishes the custom match field from other custom match fields.

8. The network device of claim 6, wherein the custom match field is based on a type-length-value (TLV) structure.

9. The network device of claim 6, wherein the custom match field is based on OpenFlow Extensible Match (OXM) format.

10. The network device of claim 6, wherein the custom match field includes a class identifier field, a field identifier field, a length identifier field, an experimenter ID field, a start type field, an offset field, and a byte size field.

11. A non-transitory machine-readable storage medium comprising instructions to match a packet field in Open Flow, the instructions executable by a processor to:
define, on a network switch, a custom match field in a flow table entry of an OpenFlow table, wherein the custom match field is defined by a Software Defined Network (SDN) controller; and
use, by the network switch, the custom match field in the flow table entry to match against a packet match field in a received packet.

12. The storage medium of claim 11, wherein the packet match field includes a packet header field.

13. The storage medium of claim 11, wherein the packet match field relates to a network protocol.

14. The storage medium of claim 11, wherein the network protocol includes one of Internet Group Management Protocol (IGMP), Generic Routing Encapsulation (GRE) protocol, and Open Shortest Path First (OSPF) protocol.

15. The storage medium of claim 11, further comprising instructions to program a flow on the network switch to match on the custom match field.
